(19) United States
(12) Patent Application Publication
(10) Pub. No.: US 2017/0111473 A1
(43) Pub. Date: Apr. 20, 2017

(54) SELECTIVE ROUTING OF ENCRYPTED REQUESTS VIA COMPUTER NETWORKS

(71) Applicant: FIREGLASS LTD., Tel Aviv (IL)

(72) Inventors: DAN AMIGA, HERZLIYA (IL); GUY GUZNER, TEL AVIV (IL)

(21) Appl. No.: 15/298,266

(22) Filed: Oct. 20, 2016

Related U.S. Application Data
(60) Provisional application No. 62/243,705, filed on Oct. 20, 2015.

(51) Int. Cl. H04L 29/08; H04L 29/06; H04L 29/12

(52) U.S. Cl. CPC H04L 67/327; H04L 61/1511; H04L 67/146; H04L 63/0281; H04L 63/0428

(57) ABSTRACT

Processing computer network requests by receiving from a requesting computer an encoded value in a domain name resolution request, where the encoded value has a valid domain name syntax, decoding the encoded value into a Uniform Resource Locator having a host portion and a non-host portion, determining that the host portion of the Uniform Resource Locator in combination with the non-host portion of the Uniform Resource Locator meets a predefined routing criterion associated with a computer network address that is associated with a proxy server, and sending the computer network address to the requesting computer in response to the domain name resolution request.

### CROSS-REFERENCE TO RELATED APPLICATIONS

This application claims the benefit of priority from U.S. Provisional Patent Application No. 62/243,705, filed Oct. 20, 2015, the disclosure of which is incorporated herein by reference in its entirety.

### BACKGROUND

Organizations often implement computer-based measures to control the types of computer network resources that their computer users may access. This is often done by monitoring requests made by a computer-user's computer, such as when a web browser requests access to a website, and forwarding the request to a policy server which analyzes the content of the request and applies predefined policies to the request content to determine whether or not the request should be allowed to proceed. Increasingly, cryptographic protocols, such as the Transport Layer Security (TLS) and Secure Sockets Layer (SSL) protocols, are employed to that encrypt such requests and thus prevent their encrypted contents from being analyzed by such policy servers. One solution to this problem is a technique known as SSL Man In The Middle (MITM), but it is labor- and resource-intensive, and often cannot be implemented due to privacy and legal issues.

### SUMMARY

In one aspect of the invention a method is provided for processing computer network requests, the method including receiving from a requesting computer an encoded value in a domain name resolution request, where the encoded value has a valid domain name syntax, decoding the encoded value into a Uniform Resource Locator having a host portion and a non-host portion, determining that the host portion of the Uniform Resource Locator in combination with the non-host portion of the Uniform Resource Locator meets a predefined routing criterion associated with a computer network address that is associated with a proxy server, and sending the computer network address to the requesting computer in response to the domain name resolution request.

In another aspect of the invention the method further includes configuring the requesting computer to encode into the encoded value the Uniform Resource Locator having the host portion and the non-host portion, where the encoded value has a valid domain name syntax, and send the encoded value in the domain name resolution request.

In another aspect of the invention the method further includes configuring the requesting computer to receive the computer network address in response to the domain name resolution request, and send a computer network resource access request to the computer network address, where the computer network resource access request includes the Uniform Resource Locator having the host portion and the non-host portion.

In another aspect of the invention the method further includes configuring the requesting computer to receive the computer network address in response to the domain name resolution request, and send a computer network resource access request to a destination computer network address and port associated with the computer network address received in response to the domain name resolution request, where the computer network resource access request includes the Uniform Resource Locator having the host portion and the non-host portion.

In another aspect of the invention the method further includes configuring the requesting computer to send the encoded value by invoking a dnsResolve method of a proxy auto-configuration file using the encoded value as a parameter of the dnsResolve method.

In another aspect of the invention the method further includes configuring the proxy auto-configuration file with software instructions for encoding the Uniform Resource Locator.

In another aspect of the invention the method further includes configuring the proxy server to block requests received at the computer network address.

In another aspect of the invention the method further includes configuring the proxy server to block requests received at the destination computer network address and port.

In another aspect of the invention the method further includes configuring the requesting computer to encode into a plurality of encoded values a Uniform Resource Locator having a host portion and a non-host portion, where each of the encoded values has a valid domain name syntax, and send the encoded values in a plurality of domain name resolution requests.

In another aspect of the invention the method further includes configuring the requesting computer to send the plurality of encoded values by invoking, for each of the plurality of encoded values, a dnsResolve method of a proxy auto-configuration file using the encoded value as a parameter of the dnsResolve method, where the invoking is performed a plurality of times corresponding to the plurality of encoded values.

In another aspect of the invention the receiving from the requesting computer includes receiving the plurality of domain name resolution requests, and the decoding includes decoding the encoded values into the Uniform Resource Locator having the host portion and the non-host portion.

In another aspect of the invention the receiving, decoding, determining, and sending are implemented in any of a) computer hardware, and b) computer software embodied in a non-transitory, computer-readable medium.

In another aspect of the invention a system is provided for processing computer network requests, the system including a URL decoder configured to receive from a requesting computer an encoded value in a domain name resolution request, where the encoded value has a valid domain name syntax, and decode the encoded value into a Uniform Resource Locator having a host portion and a non-host portion, and a proxy selector configured to determine that the host portion of the Uniform Resource Locator in combination with the non-host portion of the Uniform Resource Locator meets a predefined routing criterion associated with a computer network address that is associated with a proxy server, and send the computer network address to the requesting computer in response to the domain name resolution request.

In another aspect of the invention the requesting computer is configured to encode into the encoded value the Uniform Resource Locator having the host portion and the non-host portion, where the encoded value has a valid domain name syntax, and send the encoded value in the domain name resolution request.

In another aspect of the invention the requesting computer is configured to receive the computer network address in response to the domain name resolution request, and send a computer network resource access request to the computer network address, where the computer network resource access request includes the Uniform Resource Locator having the host portion and the non-host portion.

In another aspect of the invention the requesting computer is configured to receive the computer network address in response to the domain name resolution request, and send a computer network resource access request to a destination computer network address and port associated with the computer network address received in response to the domain name resolution request, where the computer network resource access request includes the Uniform Resource Locator having the host portion and the non-host portion.

In another aspect of the invention the requesting computer is configured to send the encoded value by invoking a dnsResolve method of a proxy auto-configuration file using the encoded value as a parameter of the dnsResolve method.

In another aspect of the invention the proxy auto-configuration file is configured with software instructions for encoding the Uniform Resource Locator.

In another aspect of the invention the proxy server is configured to block requests received at the computer network address.

In another aspect of the invention the proxy server is configured to block requests received at the destination computer network address and port.

In another aspect of the invention the requesting computer is configured to encode into a plurality of encoded values a Uniform Resource Locator having a host portion and a non-host portion, where each of the encoded values has a valid domain name syntax, and send the encoded values in a plurality of domain name resolution requests.

In another aspect of the invention the requesting computer is configured to send the encoded values by invoking, for each of the plurality of encoded values, a dnsResolve method of a proxy auto-configuration file using the encoded value as a parameter of the dnsResolve method, where the invoking is performed a plurality of times corresponding to the plurality of encoded values.

In another aspect of the invention the URL decoder is configured to receive from the requesting computer the plurality of domain name resolution requests, and decode the encoded values into the Uniform Resource Locator having the host portion and the non-host portion.

In another aspect of the invention the URL decoder and proxy selector are implemented in any of a) computer hardware, and b) computer software embodied in a non-transitory, computer-readable medium.

### BRIEF DESCRIPTION OF THE DRAWINGS

Aspects of the invention will be understood and appreciated more fully from the following detailed description taken in conjunction with the appended drawings in which:

FIG. 1A is a simplified conceptual illustration of a system for processing computer network requests, constructed and operative in accordance with an embodiment of the invention;

FIG. 1B is a simplified conceptual illustration of a system for processing computer network requests, constructed and operative in accordance with an alternative embodiment of the invention;

FIG. 2A is a simplified flowchart illustration of an exemplary method of operation of the system of FIG. 1A, operative in accordance with various embodiments of the invention; and

FIG. 2B is a simplified flowchart illustration of an exemplary method of operation of the system of FIG. 1B, operative in accordance with various embodiments of the invention.

### DETAILED DESCRIPTION

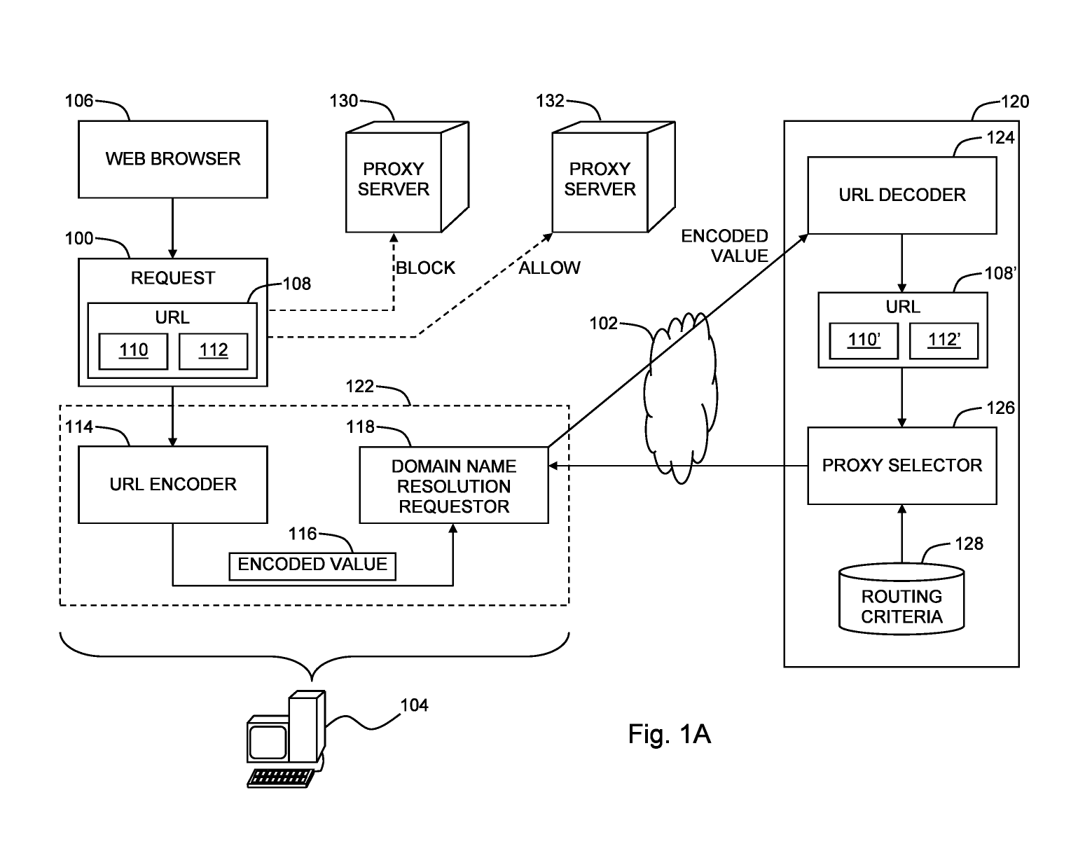

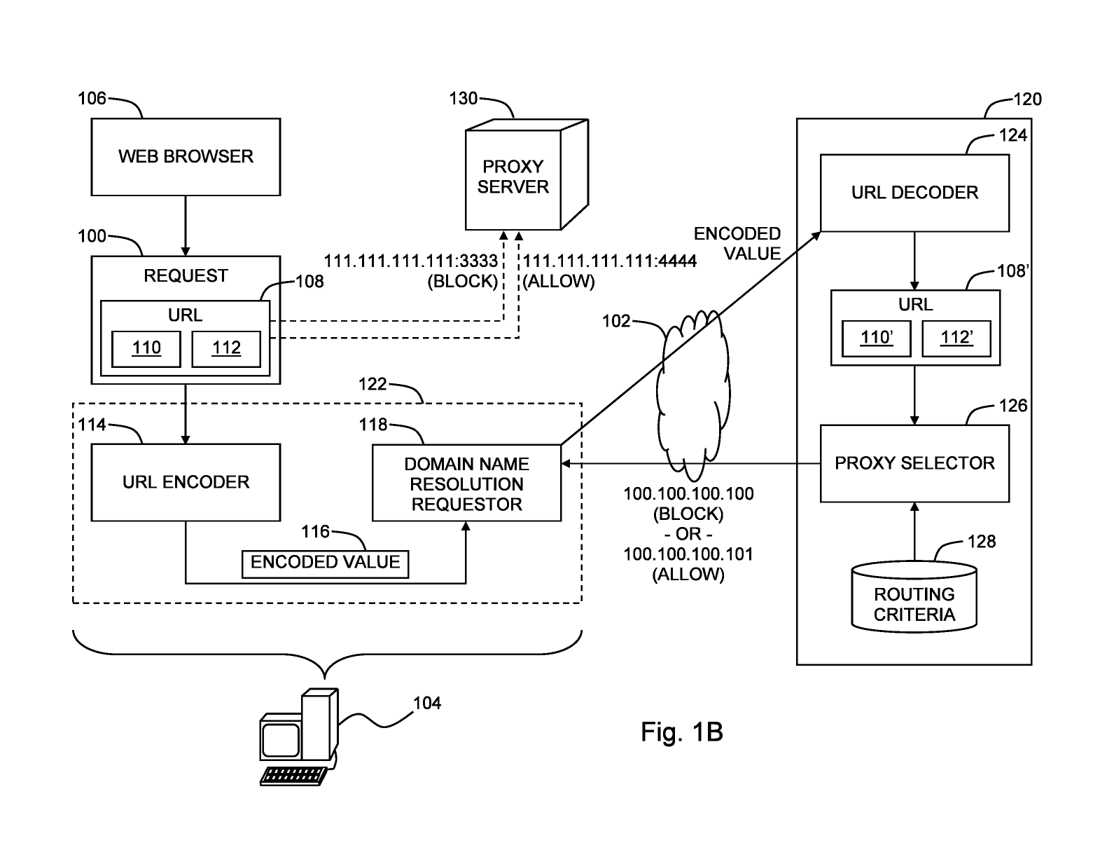

Reference is now made to FIG. 1A, which is a simplified conceptual illustration of a system for processing computer network requests, constructed and operative in accordance with an embodiment of the invention. In the system of FIG. 1A, a request 100 to access a resource via a computer network 102, such as an internal company network and/or the Internet, is identified on a computer 104 in accordance with conventional techniques. Request 100, such as a request made by a web browser 106 running on computer 104, includes a Uniform Resource Locator (URL) 108 that specifies the location of the resource on computer network 102, where URL 108 has a host portion 110, as well as one or more non-host portions collectively referred to herein as non-host portion 112, where host portion 110 together with non-host portion 112 constitute the entirety of URL 108. For example, in the URL ‘https://www.amazon.com/clouddrive/home,’ ‘www. amazon.com’ is the host portion, and ‘https://’ and ‘/clouddrive/home’ are non-host portions, where URL 106 conforms to the syntax of a generic Uniform Resource Identifier (URI) of the form:

scheme:[//[user:password@]host[:port]][/]path[?query][#fragment]

where the non-host portion 112 includes any scheme, user, password, port, path, query, and fragment portions of URL 108.

A URL encoder 114 is configured to encode URL 108, including its host portion 110 and non-host portion 112, into an encoded value 116 having a valid domain name syntax, such as is described in appear in RFC 1035, RFC 1123, and RFC 2181 of The Internet Engineering Task Force (IETF) of the Internet Society (ISOC), Fremont, Calif. URL encoder 114 is configured to encode URL 108 into encoded value 116 using any encoding technique that allows for full recovery of URL 108, including its host portion 110 and non-host portion 112, by applying a complementary decoding technique to encoded value 116. Where encoding URL 108 into a single encoded value 116 would cause the length of encoded value 116 to exceed the maximum length that a valid domain name may have, such as more than 253 characters in its textual representation, URL encoder 114 is configured to encode URL 108 into multiple encoded values 116, each having a valid domain name syntax and not exceeding the maximum length, and each preferably including one or more indicators that indicate that the encoded value 116 is one of a group of encoded values 116 into which URL 108 is encoded, as well the sequence of encoded value 116 within the group of encoded values 116, such as where each encoded value includes ‘part_n_of_m’ where n indicates the sequence number and m indicates the number of encoded values 116 into which URL 108 is encoded. URL encoder 114 is configured to encode URL 108 into such multiple encoded values 116 using any encoding technique that allows for full recovery of URL 108, including its host portion 110 and non-host portion 112, by applying a complementary decoding technique to the multiple encoded values 116.

A domain name resolution requestor 118 sends encoded value 116 in a domain name resolution request to a server 120. Where URL 108 is encoded into multiple encoded values 116, domain name resolution requestor 118 sends the multiple encoded values 116 in corresponding multiple domain name resolution requests to server 120.

In one embodiment URL encoder 114 and domain name resolution requestor 118 are implemented as software instructions within a proxy auto-configuration (PAC) file 122 with which computer 104 is configured. URL encoder 114 may, for example, be implemented using the JAVASCRIPT instruction

var encodedUrl=encode64(url).replace(“=”,“-1-”)+“.com”

while domain name resolution requestor 118 may, for example, be implemented using the JAVASCRIPT instruction

var resolvedIp=dnsResolve(encodedUrl);

where encoded value 116 is sent to server 120 by invoking the dnsResolve method using encoded value 116 as a parameter of the dnsResolve method. Where URL 108 is encoded into multiple encoded values 116, the dnsResolve method is invoked multiple times, each time using a different one of the encoded values as a parameter of the dnsResolve method.

At server 120, a URL decoder 124 is configured to receive one or more encoded values associated with a URL, such as URL 108, in one or more domain name resolution requests as described above, and decode the encoded values into a URL 108′ by applying decoding techniques that are complementary to the techniques used to create the encoded values, where URL 108′ includes all host and non-host portions 110′ and 112′ that URL 108′ included prior to its encoding as described above. A proxy selector 126 is configured to determine whether host portion 110′ of URL 108′ in combination with non-host portion 112′ of URL 108′ meets one or more predefined routing criteria 128 associated with a computer network address at a proxy server 130, and then send the computer network address in response to the domain name resolution request(s), such as to domain name resolution requestor 118. In one embodiment, different routing criteria 128 are associated with different computer network addresses at one or more proxy servers, where each computer network address is associated with a different predefined policy that its associated proxy server is configured to apply to requests that are received at the computer network address. Such policies may, for example, include security policies, where requests from users are allowed or blocked, such as based on the identity of the requestors and/or on the requested resource; throttling policies; and logging policies. Thus, for example, proxy server 130 at IP address 111.111.111.111 is configured to block all requests that it receives, such as by returning a predefined web page that is other than a requested web page, whereas a proxy server 132 at IP address 222.222.222.222 is configured to allow all requests that it receives to proceed, such as by passing such requests through to their originally-intended destinations.

Domain name resolution requestor 118 is configured, in accordance with conventional techniques, to receive computer network addresses in response to its domain name resolution requests, whereupon any computer network resource access requests whose URLs were processed as described hereinabove, such as request 100, are sent to the computer network addresses at their specified proxy servers which the process the requests by applying the predefined policies associated with the computer network addresses as described hereinabove. Where request 100 is configured to be sent using a cryptographic protocol, such as TLS or SSL, the proxy server that receives request 100 is nevertheless able to apply the predefined policy associated with the computer network address at which request 100 is received even though the proxy server is not able to peer into the encrypted contents or request 100.

In one embodiment, where URL 108 matches a predefined pattern to which a predefined policy is to be applied as described hereinabove with reference to predefined routing criteria 128, URL encoder 114 employs a dictionary to encode URL 108 into encoded value 116 using a predefined representative value. For example, in the following generated dictionary:

```
var generatedRulesDictionary = [{
    host : ‘www.linkedin.com’,
    regex: “/www.linkedin.com/messages[0-9]*’/,
    query: ‘1.fg.com’
}];
```

where URL 108 matches the indicated pattern it will be encoded into encoded value 116 using ‘1.fg.com’, which is then sent in a domain name resolution request to a server 120, whereupon proxy selector 126 applies predefined routing criteria 128 to ‘1.fg.com’ as described hereinabove.

In one embodiment, as shown in FIG. 1B, different routing criteria 128 are associated with different alias computer network addresses that represent destination computer network addresses and ports at one or more proxy servers. Thus, for example, alias IP address 100.100.100.100 represents proxy server 130 at destination IP address 111.111.111.111 port 3333 that is configured to block all requests that it receives, such as by returning a predefined web page that is other than a requested web page, whereas alias IP address 100.100.100.101 represents proxy server 130 at destination IP address 111.111.111.111 port 4444 is configured to allow all requests that it receives to proceed, such as by passing such requests through to their originally-intended destinations. In this embodiment, domain name resolution requestor 118 may, for example, be implemented in the aforementioned PAC file using the JAVASCRIPT instructions

```
var resolvedIp = dnsResolve(encodedUrl);
if (resolvedIp == ‘100.100.100.100’){
    return “PROXY l11.l11.l11.l11:3333;”; // block
} else if (resolvedIp == ‘100.100.100.101’){
    return “PROXY l11.l11.l11.l11:4444;”; // allow
}
```

Any of the elements shown in FIGS. 1A and 1B are preferably implemented in computer hardware and/or in computer software embodied in a non-transitory, computer-readable medium in accordance with conventional techniques.

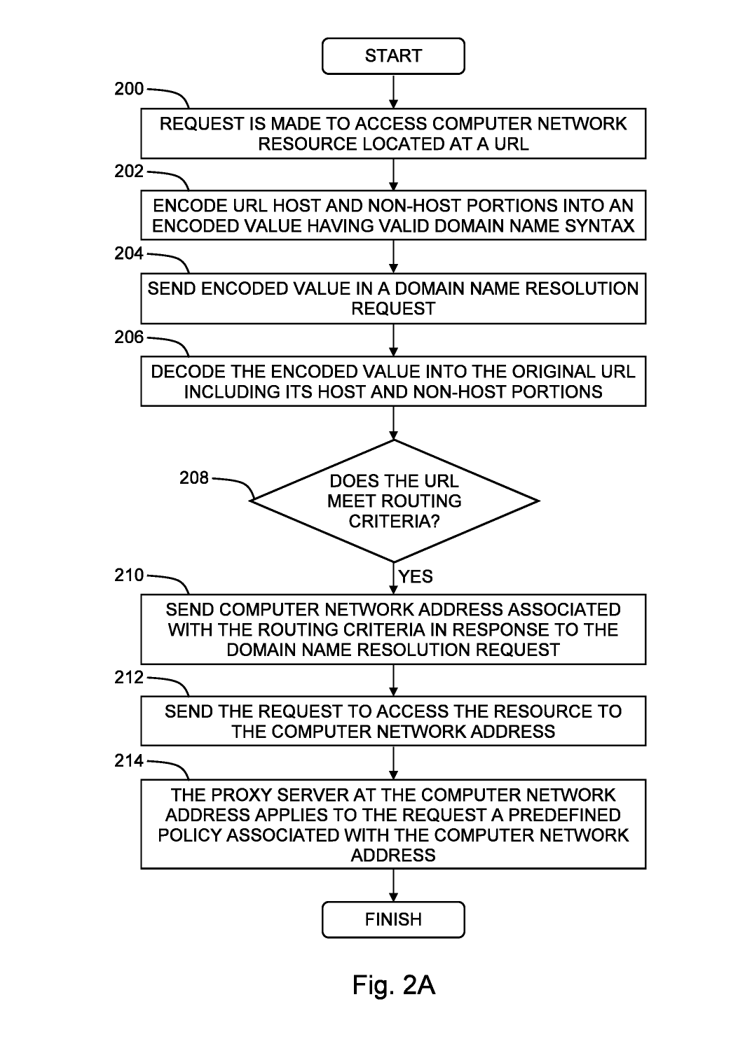

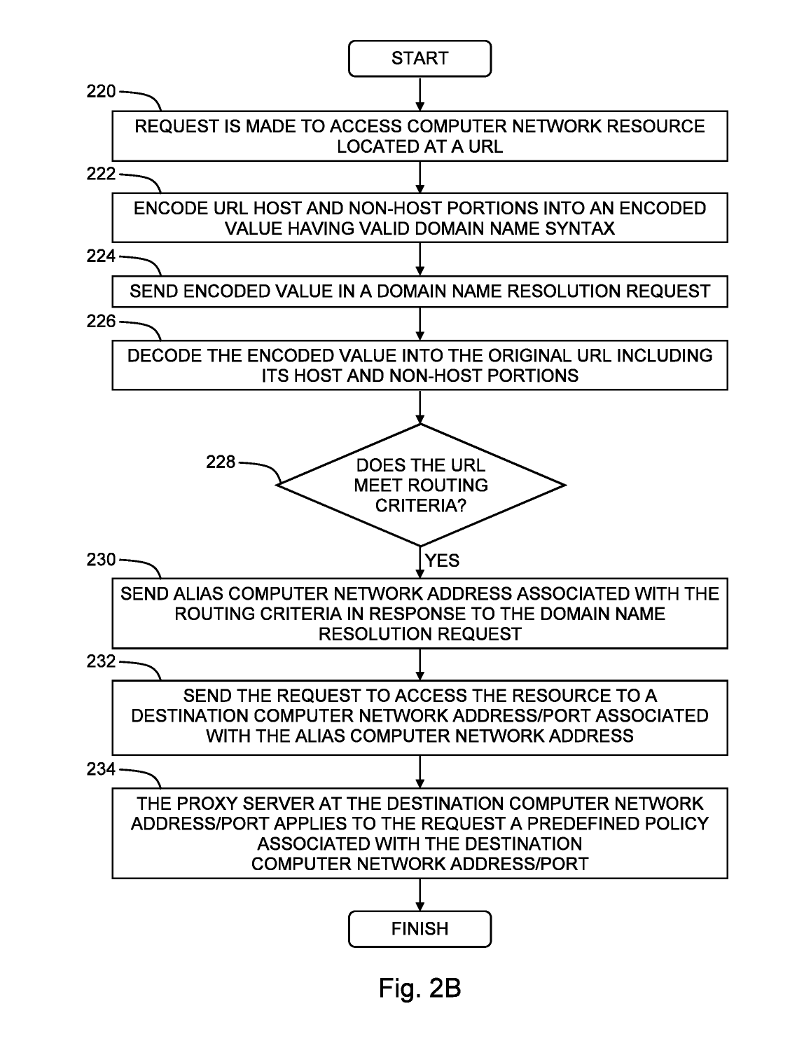

Reference is now made to FIG. 2A, which is a simplified flowchart illustration of an exemplary method of operation of the system of FIG. 1A, operative in accordance with an embodiment of the invention. In the method of FIG. 2A, a request is made on a computer to access a resource via a computer network, where the request includes a Uniform Resource Locator (URL) that specifies the location of the resource on the computer network (step 200). The URL, including its host and non-host portions, is encoded into an encoded value having a valid domain name syntax (step 202). The encoded value is sent in a domain name resolution request to a server (step 204), such as by invoking a dnsResolve method of a proxy auto-configuration (PAC) file in which encoded value is used as a parameter of the dnsResolve method. At the server, the encoded value is decoded into the URL, including its host and non-host portions (step 206), using a decoding technique that is complementary to the technique used to create the encoded value. If the URL, including its host and non-host portions, meets predefined routing criteria associated with a computer network address at a proxy server that is configured to apply a predefined policy to requests that are received at the computer network address (step 208), the computer network address is sent to the computer in response to the domain name resolution request (step 210). The request to access the resource is sent to the computer network addresses at the proxy server (step 212), which processes the request by applying the predefined policy associated with the computer network address (step 214), whether or not the request was sent using a cryptographic protocol.

Reference is now made to FIG. 2B, which is a simplified flowchart illustration of an exemplary method of operation of the system of FIG. 1B, operative in accordance with an embodiment of the invention. In the method of FIG. 2B, a request is made on a computer to access a resource via a computer network, where the request includes a Uniform Resource Locator (URL) that specifies the location of the resource on the computer network (step 220). The URL, including its host and non-host portions, is encoded into an encoded value having a valid domain name syntax (step 222). The encoded value is sent in a domain name resolution request to a server (step 224), such as by invoking a dnsResolve method of a proxy auto-configuration (PAC) file in which encoded value is used as a parameter of the dnsResolve method. At the server, the encoded value is decoded into the URL, including its host and non-host portions (step 226), using a decoding technique that is complementary to the technique used to create the encoded value. If the URL, including its host and non-host portions, meets predefined routing criteria associated with an alias computer network address that is associated with a destination computer network address and port at a proxy server that is configured to apply a predefined policy to requests that are received at the destination computer network address and port (step 228), the alias computer network address is sent to the computer in response to the domain name resolution request (step 230) where the alias computer network address is replaced with its associated destination computer network address and port. The request to access the resource is sent to the destination computer network addresses and port at the proxy server (step 232), which processes the request by applying the predefined policy associated with the computer network address and port (step 234), whether or not the request was sent using a cryptographic protocol.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

Embodiments of the invention may include a system, a method, and/or a computer program product. The computer program product may include a computer readable storage medium (or media) having computer readable program instructions thereon for causing a processor to carry out aspects of the invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the invention.

Aspects of the invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for processing computer network requests, the method comprising:
receiving from a requesting computer an encoded value in a domain name resolution request, wherein the encoded value has a valid domain name syntax;
decoding the encoded value into a Uniform Resource Locator having a host portion and a non-host portion;
determining that the host portion of the Uniform Resource Locator in combination with the non-host portion of the Uniform Resource Locator meets a predefined routing criterion associated with a computer network address that is associated with a proxy server; and
sending the computer network address to the requesting computer in response to the domain name resolution request.

2. The method according to claim 1 and further comprising configuring the requesting computer to
encode into the encoded value the Uniform Resource Locator having the host portion and the non-host portion, wherein the encoded value has a valid domain name syntax, and
send the encoded value in the domain name resolution request.

3. The method according to claim 2 and further comprising configuring the requesting computer to
receive the computer network address in response to the domain name resolution request, and
send a computer network resource access request to the computer network address, wherein the computer network resource access request includes the Uniform Resource Locator having the host portion and the non-host portion.

4. The method according to claim 2 and further comprising configuring the requesting computer to
receive the computer network address in response to the domain name resolution request, and
send a computer network resource access request to a destination computer network address and port associated with the computer network address received in response to the domain name resolution request, wherein the computer network resource access request includes the Uniform Resource Locator having the host portion and the non-host portion.

5. The method according to claim 2 and further comprising configuring the requesting computer to send the encoded value by invoking a dnsResolve method of a proxy auto-configuration file using the encoded value as a parameter of the dnsResolve method.

6. The method according to claim 5 and further comprising configuring the proxy auto-configuration file with software instructions for encoding the Uniform Resource Locator.

7. The method according to claim 1 and further comprising configuring the proxy server to block requests received at the computer network address.

8. The method according to claim 4 and further comprising configuring the proxy server to block requests received at the destination computer network address and port.

9. The method according to claim 1 and further comprising configuring the requesting computer to
encode into a plurality of encoded values a Uniform Resource Locator having a host portion and a non-host portion, wherein each of the encoded values has a valid domain name syntax, and
send the encoded values in a plurality of domain name resolution requests.

10. The method according to claim 9 and further comprising configuring the requesting computer to send the plurality of encoded values by invoking, for each of the plurality of encoded values, a dnsResolve method of a proxy auto-configuration file using the encoded value as a parameter of the dnsResolve method, wherein the invoking is performed a plurality of times corresponding to the plurality of encoded values.

11. The method according to claim 9 wherein
the receiving from the requesting computer comprises receiving the plurality of domain name resolution requests, and
the decoding comprises decoding the encoded values into the Uniform Resource Locator having the host portion and the non-host portion.

12. The method according to claim 1 wherein the receiving, decoding, determining, and sending are implemented in any of
a) computer hardware, and
b) computer software embodied in a non-transitory, computer-readable medium.

13. A system for processing computer network requests, the system comprising:
a URL decoder configured to
receive from a requesting computer an encoded value in a domain name resolution request, wherein the encoded value has a valid domain name syntax, and
decode the encoded value into a Uniform Resource Locator having a host portion and a non-host portion; and
a proxy selector configured to
determine that the host portion of the Uniform Resource Locator in combination with the non-host portion of the Uniform Resource Locator meets a predefined routing criterion associated with a computer network address that is associated with a proxy server, and
send the computer network address to the requesting computer in response to the domain name resolution request.

14. The system according to claim 13 wherein the requesting computer is configured to
encode into the encoded value the Uniform Resource Locator having the host portion and the non-host portion, wherein the encoded value has a valid domain name syntax, and
send the encoded value in the domain name resolution request.

15. The system according to claim 14 wherein the requesting computer is configured to
receive the computer network address in response to the domain name resolution request, and
send a computer network resource access request to the computer network address, wherein the computer network resource access request includes the Uniform Resource Locator having the host portion and the non-host portion.

16. The system according to claim 14 wherein the requesting computer is configured to
receive the computer network address in response to the domain name resolution request, and
send a computer network resource access request to a destination computer network address and port associated with the computer network address received in response to the domain name resolution request, wherein the computer network resource access request includes the Uniform Resource Locator having the host portion and the non-host portion.

17. The system according to claim 14 wherein the requesting computer is configured to send the encoded value by invoking a dnsResolve method of a proxy auto-configuration file using the encoded value as a parameter of the dnsResolve method.

18. The system according to claim 17 wherein the proxy auto-configuration file is configured with software instructions for encoding the Uniform Resource Locator.

19. The system according to claim 13 wherein the proxy server is configured to block requests received at the computer network address.

20. The system according to claim 16 wherein the proxy server is configured to block requests received at the destination computer network address and port.

21. The system according to claim 13 wherein the requesting computer is configured to
encode into a plurality of encoded values a Uniform Resource Locator having a host portion and a non-host portion, wherein each of the encoded values has a valid domain name syntax, and
send the encoded values in a plurality of domain name resolution requests.

22. The system according to claim 21 wherein the requesting computer is configured to send the encoded values by invoking, for each of the plurality of encoded values, a dnsResolve method of a proxy auto-configuration file using the encoded value as a parameter of the dnsResolve method, wherein the invoking is performed a plurality of times corresponding to the plurality of encoded values.

23. The system according to claim 21 wherein the URL decoder is configured to
receive from the requesting computer the plurality of domain name resolution requests, and
decode the encoded values into the Uniform Resource Locator having the host portion and the non-host portion.

24. The system according to claim 13 wherein the URL decoder and proxy selector are implemented in any of
a) computer hardware, and
b) computer software embodied in a non-transitory, computer-readable medium.
